(19) United States
(12) Patent Application Publication
(10) Pub. No.: US 2008/0272985 A1
(43) Pub. Date: Nov. 6, 2008

(54) Display Panel

(75) Inventor: Roy Van Dijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,414

(22) PCT Filed: Nov. 24, 2004
(86) PCT No.: PCT/IB04/52530

§ 371 Date: Jun. 13, 2006

(30) Foreign Application Priority Data
Dec. 16, 2003 (EP) 03104721.0

(51) Int. Cl. G09G 3/20

(52) U.S. Cl. 345/55

(57) ABSTRACT

A display panel comprises a plurality of pixels (1-4; 22; 57). Each of the pixels (1-4; 22; 57) comprises a plurality of sub-pixel elements (5-9; 31-46; 48-56) occupying respective continuous sub-pixel element areas within a pixel area. At least two non-adjacent sub-pixel elements (5,7; 45, 46; 52,53) are coupled to receive substantially a same driving signal. The coupling may be realized via a conductor (21) or by coupling the at least two non-adjacent sub-pixel elements (5,7; 45,46; 52,53) to respective driver circuits receiving substantially a same input signal.

The invention relates to a display panel comprising a plurality of pixels. The invention also relates to a display device.

U.S. Pat. No. 5,208,689 shows a display device comprising an electro-optical medium positioned between two supporting plates in which pixels divided into a plurality of sub-pixels are defined on at least one of the supporting plates by means of picture electrodes. One sub-pixel has a surface area, which is at most equal to that of one of the other sub-pixels and is adjustable at a plurality of transmission levels while the other sub-pixels are exclusively switchable between two extreme transmission states. In one embodiment, a row electrode and a column electrode are divided into sub-electrodes whose widths are in a ratio of 4:2:1:1. At the area of the crossings of the electrodes a cell is defined which can entirely or partly change its electro-optical properties by suitable driving of the sub-electrodes. Since the electrode is divided into sub-electrodes, it is possible to drive only a portion of the display cell. In this way different surface areas of the display cell can be driven so that different ratios of light transmissive/light opaque areas, in other words different grey scales, are obtained.

A problem of the known display device is that raster patterns appear, especially when only the largest sized sub-electrodes in a number of cells in a row are driven and the others are not.

It is an object of the invention to provide a display panel and display device of the types mentioned above that enables a more homogeneous image to be achieved.

This object is achieved by the display panel according to the invention in that the display panel comprises a plurality of pixels, each comprising a plurality of sub-pixel elements occupying respective continuous sub-pixel element areas within a pixel area, at least two non-adjacent sub-pixel elements being coupled to receive substantially a same driving signal.

Thus, by notionally dividing a sub-pixel element into at least two non-adjacent sub-pixel elements receiving substantially the same driving signal, the area occupied by these at least two sub-pixel elements is ‘spread out’ over the pixel area. This leads to a more uniform image in which no patterns are perceivable. Additionally, the likelihood of image artifacts due to spatial interference between the image and the pattern of the plurality of pixels, for example a matrix of pixels, is reduced.

In a preferred embodiment, each of the pixels comprises sub-pixel members formed by either the at least two sub-pixel elements coupled to receive the same driving signal or a sub-pixel element coupled to receive a unique driving signal, respective sizes of areas occupied by the respective sub-pixel members forming a series of increasing sizes.

This increases the number of grey-scale levels, which can be achieved merely by switching sub-pixel set members on or off.

Preferably, the series has an ordinal x, a cumulative value of the sizes of the members with ordinal x or lower increasing according a power law of the ordinal x.

This embodiment has the particular advantage that the display panel has an inbuilt gamma correction due to the increase with the power law. Gamma correction in the driving electronics is not, or only to a limited extent, necessary for this embodiment to, for example, compensate for a gamma pre-correction present in a transmission system or to adapt the gamma of the image to be displayed to improve the perceived image quality.

Although the invention is applicable to any type of transmissive, reflective, transflective, or active light-emitting display, it is particularly useful in an embodiment in which the switching speed of the sub-pixel elements is relatively slow, so that time modulation would be visible to the human eye, such as roll-blind displays, for example, an electropolymeric shutter display. To make such a display, a substrate is covered with transparent column electrodes. These electrodes are covered with a thin dielectric to electrically isolate the column electrodes. A foil is deposited which is covered with a conductive row electrode. This foil is glued to the dielectric on one side of every column of pixels. The row electrodes are in between the dielectric and the foil. In reflective mode, the front side of the foil is covered with a white or colored layer to reflect the ambient light. Rectangular cuts are made on three sides after which it is heated to shrink the foil which in turn rolls up. This opens up the pixel giving a white pixel in transmissive mode or a dark pixel in reflective mode. When a certain voltage difference is applied between the columns and rows, the electrostatic force rolls down the foil to the substrate, thereby covering the pixel and creating a dark pixel in transmissive mode or a white pixel in reflective mode. Further details are provided inter alia in U.S. Pat. No. 3,989,357 and U.S. Pat. No. 5,519,565.

Because such display panels are generally large and have pixels with large display areas, it is relatively easy to provide the sub-division into smaller areas occupied by sub-pixel elements. Electromechanical displays are not very amenable to intensity control by amplitude modulation. Furthermore, time modulation is problematic due to their relatively large switching times. Varying the intensity by selective switching of parts of the display area of the pixel overcomes these disadvantages.

In one embodiment of the display panel, the pixel comprises a first and a second sub-pixel for providing light of differing colors, parts of a display area occupied by sub-pixel elements belonging to the first sub-pixel being interspersed with parts of the display area occupied by sub-pixel elements belonging to the second sub-pixel.

This allows for better color mixing and a more uniform display by reducing the visibility of raster patterns. Especially, when only one color is displayed on a (section of a) row, the visibility of raster patterns is reduced.

The at least two non-adjacent sub-pixel elements may be coupled via a conductor or may be coupled to respective driver circuits receiving substantially a same input signal.

In both embodiments light emanates from dispersed parts of the pixel area when the at least two non-adjacent sub-pixel elements are turned on simultaneously, so that the likelihood of raster patterns being perceivable is reduced.

According to another aspect of the invention, the display device according to the invention comprises a display panel according to the invention; and a driver circuit for providing driving signals to sub-pixel elements.

The invention will be explained in further detail with reference to the accompanying drawings, in which:

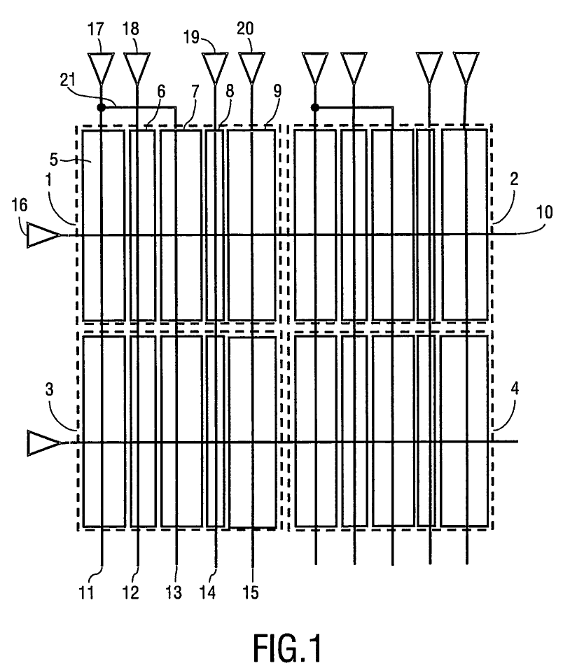

FIG. 1 shows four pixels in a first embodiment of a display panel;

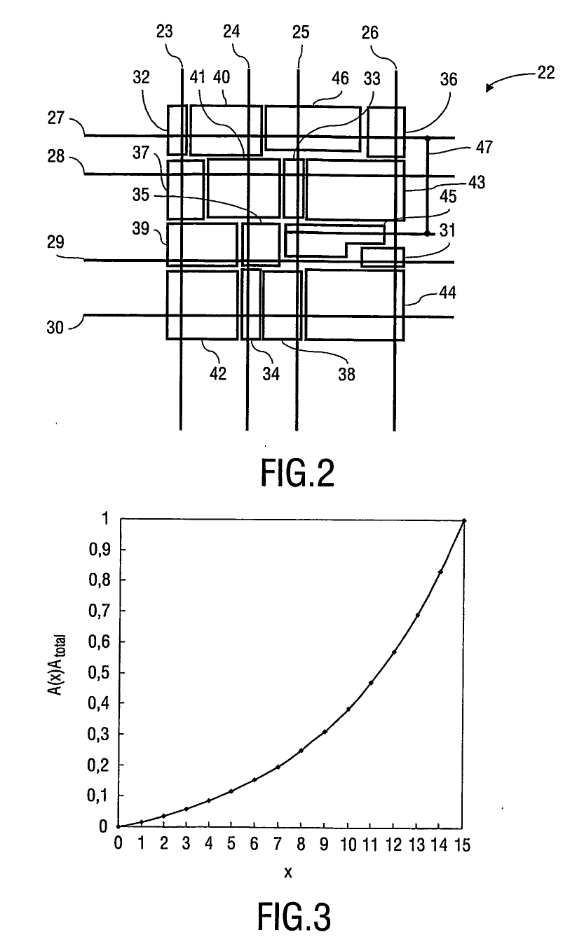

FIG. 2 shows a pixel in a variant of the display panel of FIG. 1 with in-built gamma correction;

FIG. 3 shows the distribution of the area of a pixel in the embodiment of FIG. 2 usable for display over the sub-pixel elements;

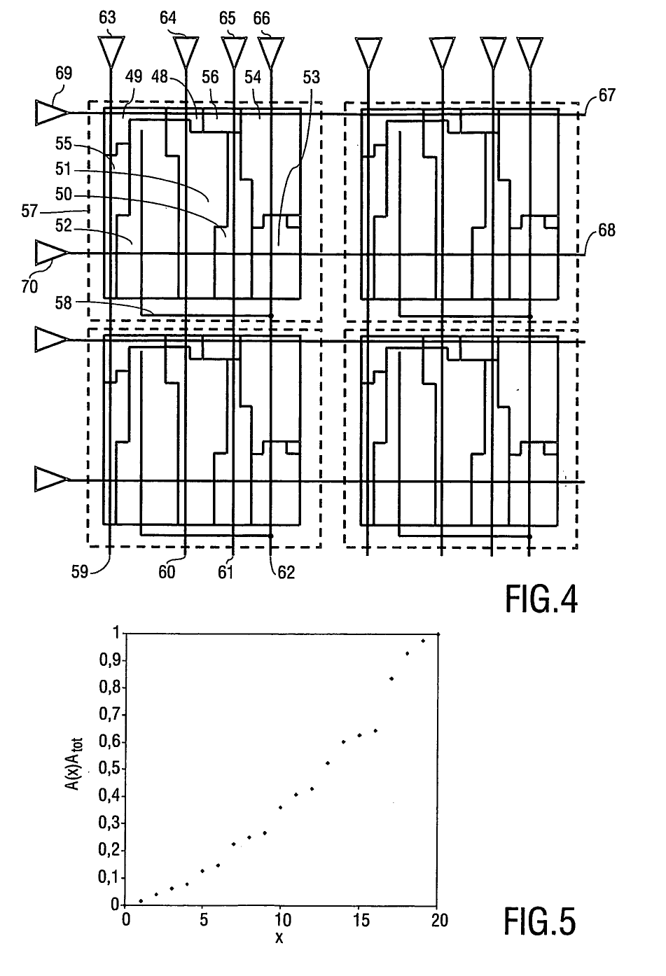

FIG. 4 shows four pixels in a third embodiment of the display panel;

FIG. 5 shows the dependency on the input signal value of the area used for display in a preferred method of driving the display panel shown in FIG. 4; and

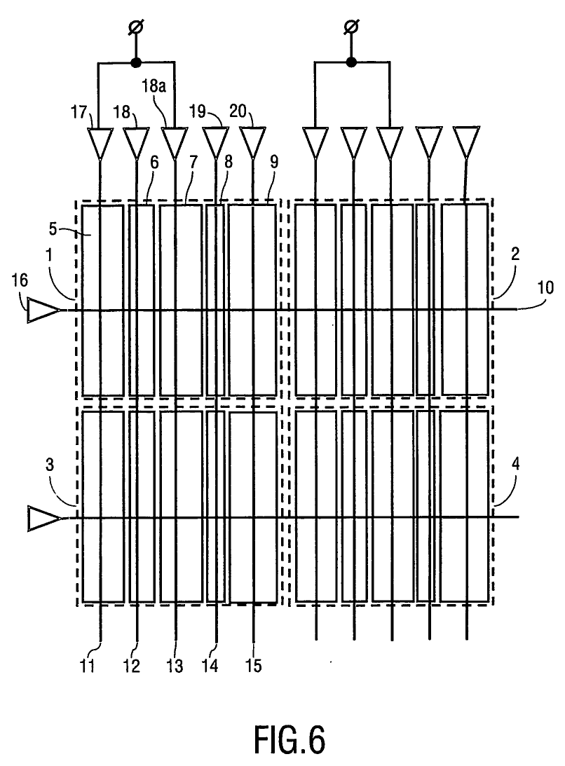

FIG. 6 shows an alternative for the first embodiment.

A section of a first embodiment of the display panel of the invention is shown in FIG. 1. The display panel comprises a matrix of pixels 1-4, arranged in rows and columns. FIGS. 1 and 2 show only sections of a display panel. Display panels more representative of the invention will generally comprise many more pixels, for example in the common standard resolutions of 832×624, 1024×768, 1280×960 or 1600×1200 pixels. FIG. 1 is plan view of the side of the display panel from which, in use, light emanates. Each pixel 1-4 occupies a certain area from which the light emanates, i.e. which is usable in forming an image. As is indicated in respect of the first pixel 1, the first pixel 1 comprises a plurality of sub-pixel elements 5-9, each occupying a continuous sub-pixel element area forming part of the area of the first pixel 1 that is usable for forming an image.

The types of display technologies usable in conjunction with the display panels presented herein will be indicated in more detail below. They comprise at least reflective, transmissive, transflective and active light-emitting pixels. In the case of reflective displays, light is reflected off the usable areas of the sub-pixel elements 5-9 to an extent commensurate with driving signals provided to each of the sub-pixel elements 5-9. In a transmissive display, light generated from behind passes through the sub-pixel elements 5-9 to an extent commensurate with driving signals provided to each of the sub-pixel elements 5-9. In a transflective display, a part of the pixel light is reflected off the usable areas of the sub-pixel elements 5-9 to an extent commensurate with driving signals provided to each of the sub-pixel elements 5-9. In another part of the same pixel light generated from behind or from a side of the panel passes through the sub-pixel elements 5-9 to an extent commensurate with driving signals provided to each of the sub-pixel elements 5-9. In an active light-emitting display, light is generated inside each of the sub-pixel elements to an extent commensurate with driving signals provided to the respective sub-pixel elements 5-9.

Driving signals are provided to the sub-pixel elements 5-9 in the first pixel 1 through a row line 10 and a number of column lines 11-15. Signals on the row line 10 are generated by a row driver 16, signals on the column lines 11-15 are generated by column drivers 17-20. In this example, when the row line 10 is set to an appropriate voltage by the row driver 16 and an appropriate voltage is set on one of the column lines 11-15, a driving signal is supplied to, for example, the sub-pixel element 5 at the intersection of the row line 10 and the column line. The signal determines whether that sub-pixel element 5 is switched into or out of an operative state, in which light emanates from the sub-pixel element area occupied by that sub-pixel element 5. It is noted that the term switching is not intended to convey the impression that the sub-pixel elements 5-9 may only be switchable between two discrete states. Although such an embodiment is possible, and indeed the only one possible for certain types of display technology, it is also possible that the intensity of light emanating from sub-pixel element areas is additionally amplitude modulated. This would, in fact, confer the advantage of providing a larger number of grey levels.

According to the invention as depicted in FIG. 1, a first sub-pixel element 5 and a third sub-pixel element 7 constitute a sub-pixel element group. The first and third sub-pixel elements 5, 7 occupy areas within the total usable area of the first pixel 1 that are separated by the area occupied by a second sub-pixel element 6, which does not belong to the sub-pixel element group. Whether sub-pixel elements 5-9 belong to the same sub-pixel element group is determined by whether they are arranged to be driven in accordance with the same driving signal. In the example of FIG. 1; a connecting conductive lead 21 connects a third column line 13 to a first column line 11, so that the intensity of light emanating from the areas occupied by the first and third sub-pixel elements 5, 7 is determined by the signal provided by a first column driver 17.

In effect, the first and third sub-pixel elements 5, 7, behave as if they were one sub-pixel element. However, they do not occupy one single continuous area. In the matrix display as a whole, the intensity of light emitted by each pixel 1 is thus controllable by switching more or less sub-pixel elements into a state in which light emanates from them. By using a group of sub-pixel elements occupying discrete and dispersed sub-pixel element areas, a large area can be turned into this state without raster effects appearing in the matrix as a whole.

The same effect is achieved by a corresponding embodiment shown in FIG. 6, in which the link between sub-pixel element belonging to a single group is achieved by an appropriate coupling of driver circuits, rather than by connecting the first and third column lines 11, 13 to the same column driver 17. In this embodiment as shown in FIG. 6, compared to FIG. 1 the connecting conductive lead 21 is dispensed with. Rather, an additional column driver 18a is used to provide a signal on the third column line 13. The additional column driver 18a is used to provide the same driving signal to the third sub-pixel element 7 as is provided to the first sub-pixel element 5. This may be achieved by providing a same input signal to the driver 17 and the additional driver 18a. Alternatively, there may be a fixed dependency between the values of the two driving signals, in that they are both derived from a shared input signal.

The embodiment shown in FIG. 1, just like the other illustrated embodiments, is a monochrome display, for easier explanation of the inventive principles. However, in a color display embodiment, a pixel comprises at least two sub-pixels, usually three. Each sub-pixel in such a pixel is adapted to allow only light within a specific color range, differing per sub-pixel, to emanate from the sub-pixel area occupied by each respective sub-pixel. This adaptation can be achieved by appropriate filters or by sub-pixel elements that actively emit a specific color of light. In a reflective display, the reflective area can alternatively or additionally be of a different color for each sub-pixel. In a color display, each sub-pixel may be structured the same way as one of the pixels 1-4 shown in FIG. 1. Alternatively, parts of the area of one pixel occupied by sub-pixel elements belonging to a first sub-pixel, for example a green one, may be interspersed with parts of the usable area of the pixel belonging to a different one of the sub-pixels, for example a red one. This further contributes to the reduction in the number of image artifacts due to rastering, as well as providing a better color mix when colors in between the different sub-pixel color ranges are to be displayed.

The present description will continue to describe other monochrome embodiments, in the understanding that they may also be adapted to provide a color display embodiment in a similar fashion.

One may regard the total area of a pixel from which light emanates as being divided into parts, each occupied by a member of a sub-pixel set. The sub-pixels elements or groups of sub-pixel elements switched in accordance with a shared driving signal constitute the members of such sub-pixel sets. It is preferred that the respective areas occupied by the members of the set increase with each further sub-pixel set member, i.e. that they can be ordered from small to large. Thus, one can provide a panel with an in-built gamma correction. This gamma correction is best if the total area occupied by i sub-pixel set members occupying the smallest areas increases with i according to a power law.

FIG. 2 shows a single pixel 22 in a first embodiment conforming to the requirement of increasing usable area according to the power law. In this embodiment, there are four column lines 23-26 for each column of pixels 22 and four row lines 27-30 for each row of pixels 22. The pixel 22 is divided into sixteen sub-pixel elements 31-46, which form fifteen sub-pixel set members. The first fourteen sub-pixel elements 31-44, counting from small to large, are each singly a member of the sub-pixel element set. Two sub-pixel elements 45,46 together form the sub-pixel set member of which the sub-pixel elements occupy the largest area. These two sub-pixel elements 45,46 are arranged to be switched together in accordance with a shared driving signal, namely when a signal is provided on both a third column line 25 and a first row line 27. A connecting conductive lead 47 is used to ensure that the two sub-pixel elements 45,46 are driven in accordance with the same driving signal.

A signal value representative of the intensity of light to be emanated by the pixel 22 is received each frame time. In the shown embodiment, each sub-pixel element 31-46 has a memory, either because an active electrical circuit has been provided or due to inherent physical effects, so that the sub-pixel elements 31-46 may be switched into or out off the operative state row-by-row. An input signal value should conveniently have a discrete value between zero and fifteen. A value x results in the switching into an operative state of the sub-pixel elements 31-46 forming the x sub-pixel set members occupying the x smallest areas in the pixel 22. Thus, an input signal value of five would result in switching the five smallest sub-pixel set members 31-34 into a state in which light emanates from the areas occupied by these sub-pixel set members 31-34. So, the light is proportional to the cumulative value of the sizes of these areas.

FIG. 3 shows how the fraction of the display area of the pixel 22 that is occupied by sub-pixel elements in an operative state, in which light emanates from them, varies with the input signal value. It can be seen to increase with a power law from zero to one. In the example of FIG. 2, the display has an in-built gamma factor of 2.5. This is achieved by allocating to the various sub-pixel elements fractions of the total usable pixel area in accordance with table 1. As mentioned before, the sub-pixel elements 45, 46 together form the sub-pixel set member with the largest area, occupying a fraction 0,1584.

TABLE 1

| Sub-pixel element no. | Fraction of area occupied |
|---|---|
| 31 | 0.0011 |
| 32 | 0.0053 |
| 33 | 0.0114 |
| 34 | 0.0188 |
| 35 | 0.0274 |
| 36 | 0.0370 |
| 37 | 0.0476 |
| 38 | 0.0590 |
| 39 | 0.0711 |
| 40 | 0.0840 |
| 41 | 0.0976 |
| 42 | 0.1119 |
| 43 | 0.1268 |
| 44 | 0.1423 |
| 45 | 0.079213 |
| 46 | 0.079213 |

Thus, the pixel 22 comprises a set of fifteen sub-pixel set members. In a color display, the set of sub-pixel set members would correspond to a sub-pixel, i.e. all the sub-pixel set members adapted to emit light within one distinct color range.

The set of all sub-pixel set members may be adapted to allow an ordered series of partitions into two sub-sets, with only the sub-pixel set members in a first of the two sub-sets being in the operative state. The ordered series of partitions is a series of partitions in which the first sub-set in each further partition in the series comprises one more of the sub-pixel set members. The total area occupied by the members of the first sub-set increases approximately according a power law of the ordinal of the partition in the series. It reaches a maximum when all the sub-pixel set members, so all the sub-pixel elements 31-46, are comprised in the first sub-set Suppose that there are N partitions. The input signal lies within a prescribed range. A partition having an ordinal proportional to the input signal is selected. In the shown example, the ordinal is numerically equal to the input signal value x. x reaches its maximum N when the input signal is at or above a value at one end of the prescribed range, for example the maximum. Then, the fraction of the maximum area occupied by the sub-pixel elements 31-46 increases as:

(x/N)^{γ}.

The exponent gamma γ preferably lies between 2 and 3, because this compensates for the characteristics as may be used in TV-systems. That means that within this range, no further gamma correction is necessary elsewhere in a display device with such a display panel.

FIG. 4 is a plan view of a section of an alternative embodiment of a display panel, which requires fewer row lines and row drivers. It has the same property of increasing display area according to a power law, but in this case, the number of sub-pixel elements 48-56 in the first sub-set of each partition in the ordered series does not increase linearly with the ordinal of the partition. Instead different combinations of sub-pixel elements 48-56 in the first of the two sub-sets in each partition, the sub-set formed by the sub-pixel elements 48-56, are switchable in an operative state. Again, this being a monochrome display, the partitions are on the set of all sub-pixel elements 48-56 comprised in one pixel 57. Note that, in this example too, two sub-pixel elements 52,53 are arranged to be switched together in accordance with a shared driving signal. As in the example of FIG. 2, a connecting conductive lead 58 ensures that this is the case. The area occupied by the two sub-pixel elements 52,53 is separated by a part of the total area of the pixel 57 occupied by two different sub-pixel elements 50,51.

Compared with the embodiment of FIG. 2, the pixel 57 of FIG. 4 comprises fewer sub-pixel elements 48-56, namely nine instead of sixteen. Thus, the fraction of the total area that is switched “on” increases only approximately according a power law with the ordinal of the partition, and not exactly. However, fewer column lines 59-62, column drivers 63-66, row lines 67,68 and row drivers 69,70 are needed in this embodiment, namely only so many to enable eight different sub-pixel elements to be separately addressed. Recall that, thanks to the connecting conductive lead 58, two sub-pixel elements 52,53 are always addressed together.

Table 2 shows the fraction of the total usable area occupied by each sub-pixel element 48-56. Table 3 shows the ordered series of partitions of the set of all sub-pixel elements 48-56 in the pixel 57.

FIG. 5 shows how the fraction of the area occupied by pixels that are switched on increases approximately according to a power law of the ordinal of the partition.

TABLE 2

| | Fraction of area |
|---|---|
| Sub-pixel element no. | occupied |
| 48 | 0.016 |
| 49 | 0.039 |
| 50 | 0.118 |
| 51 | 0.212 |
| 52 | 0.251 |
| 53 | 0.106 |
| 54 | 0.165 |
| 55 | 0.071 |
| 56 | 0.024 |

TABLE 3

| | Sub-pixel elements in first of |
|---|---|
| Partition ordinal no. | two sub-sets |
| 1 | 48 |
| 2 | 48, 56 |
| 3 | 49, 56 |
| 4 | 48, 49, 56 |
| 5 | 48, 49, 55 |
| 6 | 48, 49, 55, 56 |
| 7 | 48, 50, 55, 56 |
| 8 | 49, 50, 55, 56 |
| 9 | 48-50, 55, 56 |
| 10 | 48-50, 54, 56 |
| 11 | 48-50, 54, 55 |
| 12 | 48-50, 54-56 |
| 13 | 48, 49, 51, 54-56 |
| 14 | 48, 50, 51, 54-56 |
| 15 | 49-51, 54-56 |
| 16 | 48-51, 54-56 |
| 17 | 48-53, 55, 56 |
| 18 | 48-54, 56 |
| 19 | 48-55 |
| 20 | 48-56 |

As mentioned above, the display panels illustrated herein may be of a transmissive, reflective, transflective, or active light-emitting type. The shown techniques can be applied to very large displays (e.g. displays occupying a complete facade of a building and using shutters in the windows) to relatively small displays (e.g. the screen of a Personal Digital Assistant or mobile phone). The pixel configurations and method of driving the display panel illustrated herein are in particular suited to display panels comprising slowly switching sub-pixel elements, e.g. electromechanical displays. The latter types of displays are often large, e.g. several meters by several meters. They are more amenable to driving by means of switching than by means of amplitude modulation. By means of the pixel configurations illustrated herein an adequate number of intensity levels and an adequately high frequency of display (i.e. sufficiently short frame times) can be achieved. For the same reasons, the invention may be used in roll blind displays.

The invention may also be used in connection with gas-discharge displays, electrochromic displays, electrophoretic displays, Liquid Crystal Displays, and also in displays using electrostatically charged or magnetic balls or particles, known colloquially as E-Paper.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

For instance, other dimensions may be used to create display panels with an in-built gamma correction, such as those demonstrated in FIGS. 2 and 4.

1. Display panel comprising a plurality of pixels (1-4; 22; 57), each comprising a plurality of sub-pixel elements (5-9; 31-46; 48-56) occupying respective continuous sub-pixel element areas within a pixel area, at least two non-adjacent sub-pixel elements (5,7; 45,46; 52,53) being coupled to receive substantially a same driving signal.

2. Display panel according to claim 1, each of the pixels (1-4; 22; 57) comprising sub-pixel members formed by either the at least two sub-pixel elements coupled to receive the same driving signal or a sub-pixel element (5-9; 31-46; 48-56) coupled to receive a unique driving signal, respective sizes of areas occupied by the respective sub-pixel members forming a series of increasing sizes.

3. Display panel according to claim 2, the series having an ordinal x, a cumulative value of the sizes of the members with ordinal x or lower increasing according to a power law of the ordinal x.

4. Display panel according to claim 3, the series having N members, the cumulative value of the sizes as a fraction of the cumulative value for x=N increasing substantially with the ordinal x as:
(x/N)^{γ}, wherein γ is an exponent, with 1≦γ≦4.

5. Display panel according to claim 1, the display panel being an electromechanical display panel.

6. Display panel according to claim 1, the at least two non-adjacent sub-pixel elements being coupled via a conductor (21; 47; 58).

7. Display panel according to claim 1, the at least two non-adjacent sub-pixel elements being coupled to respective drivers (17, 18a) receiving substantially a same input signal.

8. Display panel according to claim 1, each of the plurality of pixels (14; 22; 57) comprising a first and a second sub-pixel for providing light of mutually differing colors, parts of a display area occupied by sub-pixel elements belonging to the first sub-pixel being interspersed with parts of the display area occupied by sub-pixel elements belonging to the second sub-pixel.

9. Display device comprising a display panel according to claim 1; and a driver for providing driving signals to sub-pixel elements (5,7; 45,46; 52,53).
